(19) United States
(12) Patent Application Publication
(10) Pub. No.: US 2005/0284403 A1
(43) Pub. Date: Dec. 29, 2005

(54) Pet carrier

(76) Inventor: Jody Craig Delino, Round Rock, TX (US)

Correspondence Address: DAVID ODELL SIMMONS, 7637 PARKVIEW CIRCLE, AUSTIN, TX, 78731, US

(21) Appl. No.: 10/858,422

(22) Filed: Jun. 1, 2004

(51) Int. Cl. A01K 1/03

(52) U.S. Cl. 119/497

(57) ABSTRACT

A pet carrier comprises a carrier body, a plurality of containment members and a carrier support apparatus attached to the carrier body. The carrier body has a window in at least one wall thereof. The plurality of containment members are mounted on the carrier body and extend at least partially across the window. At least a portion of the containment members are selectively demountable from and remountable on the carrier body. The carrier support apparatus is selectively attachable to and detachable from the carrier body and is configured for being attached to a structural component of a cycle. Further, the carrier support apparatus includes a universal mounting base configured for being selectively attachable to and detachable from the carrier body and includes an application-specific mounting bracket configured for being attached between the universal mounting base and a structural component of a designated cycle.

### FIELD OF THE DISCLOSURE

The disclosures made herein relate generally to cargo carriers for cycles (e.g., motorcycle, bicycle, all-terrain vehicle, and the like) and, more particularly, to pet carriers configured for attachment to cycles.

### BACKGROUND

Various types of cargo carriers used for carrying cargo on a cycle are known. Examples of such types of cargo carriers (i.e., conventional cargo carriers) include application-specific cargo enclosures, custom-made cargo enclosures, universal cargo carriers, saddlebags, tank packs and the like. Such types of cargo carriers may be specifically designed for being attached to a cycle or may be adapted for being mounted on a motorcycle (e.g., temporarily attached with off-the-shelf straps).

Such conventional cargo carriers and associated means for carrying cargo exhibit one or more limitations that adversely affect their effectiveness, desirability and/or practicality in carrying a pet on a cycle. One limitation is that they are unsafe due to their means of attachment to the cycle and/or the containment space provided for the pet. For example, strapping a generic, store-bought pet carrier onto a seat or fender of a motorcycle with off-the-shelf straps creates a dangerous condition for the rider, the pet and other vehicles/pedestrians. Another limitation is that they do not provide for detachability from the cycle in a convenient manner. For example, tools are required for removal in some cases and others incorporate cumbersome release mechanisms. Another limitation is that they do not provide for detachability from the cycle in a safe manner. For example, straps are convenient but far from safe. Another limitation is that they do not allow the pet exposure to the elements such that the pet can enjoy riding experience. Another limitation is that they are not configured to compliment the artistic styling of the cycle. Another limitation is that they are not readily configurable for use with a variety of different cycle constructions, which adversely affects their price.

Therefore, a pet carrier and/or means for carrying a pet on a cycle that overcomes limitations associated with conventional pet carriers and means for carrying pets on a cycle would be useful and novel.

### SUMMARY OF THE DISCLOSURE

In one embodiment, a pet carrier comprises a carrier body and a plurality of containment members. The carrier body has a window in at least one wall thereof. The plurality of containment members are mounted on the carrier body and extend at least partially across the window. At least a portion of the containment members are selectively demountable from and remountable on the carrier body.

In another embodiment, a pet carrier comprises a carrier body and a carrier support apparatus attached to the carrier body. The carrier support apparatus is selectively attachable to and detachable from the carrier body and is configured for being attached to a structural component of a cycle. Further, the carrier support apparatus includes a universal mounting base configured for being selectively attachable to and detachable from the carrier body and includes an application-specific mounting bracket configured for being attached between the universal mounting base and a structural component of a designated cycle.

In still another embodiment, a pet carrier system comprises a carrier body assembly, containment members and a carrier support apparatus. The carrier body assembly includes a carrier body and a support member. The carrier body has a window in a wall thereof and a support member mounted thereon extending at least partially across the window. The containment members are selectively mountable on and demountable from the carrier body for extending at least partially across the window. The containment members are attached to the support member. The carrier support apparatus is selectively attachable to and detachable from the carrier body and configured for being attached to a structural component of a cycle.

Accordingly, it is a principal object of the inventive disclosures made herein to provide a novel and advantageous pet carrier that overcomes limitations associated with conventional pet carriers and that is configured for being mounted on a cycle. Specifically, pet carriers in apparatuses in accordance with embodiments of the disclosures made herein provide a safe means of attachment to the cycle, provide a safe containment space provided for a pet, provide for detachability from the cycle in a convenient manner, provide for detachability from the cycle in a safe manner, allow the pet exposure to the elements such that the pet can enjoy riding experience, are configured to compliment the artistic styling of the cycle and/or are configurable for use with a variety of different cycle constructions.

In at least one embodiment of the inventive disclosures made herein, a support member is mounted on the carrier body and extends at least partially across the window.

In at least one embodiment of the inventive disclosures made herein, at least a portion of the containment members are attached to or attachable to the support member.

In at least one embodiment of the inventive disclosures made herein, a carrier support apparatus is provided, which is attached to the carrier body, is selectively attachable to and detachable from the carrier body and/or is configured for being attached to a structural component of a cycle.

In at least one embodiment of the inventive disclosures made herein, a carrier support apparatus is provided, which includes a universal mounting base configured for being selectively attachable to and detachable from the carrier body and includes an application-specific mounting bracket configured for being attached between the universal mounting base and the structural component of a designated cycle.

In at least one embodiment of the inventive disclosures made herein, a latching member is provided, which is mounted on the carrier body, is engaged with a respective mating member of the carrier support apparatus, and/or is selectively engagable with and disengagable from the respective mating member of the carrier support apparatus.

In at least one embodiment of the inventive disclosures made herein, a retention bracket is provided, which is mounted on the carrier body, is engaged with a respective mating member of the carrier support apparatus, and/or is engagable with and disengagable from the respective mating member of the carrier support apparatus.

In at least one embodiment of the inventive disclosures made herein, an alignment member is provided, which is mounted on the carrier body, is engaged with a respective mating member of the carrier support apparatus and/or is engagable with and disengagable from the respective mating member of the carrier support apparatus.

In at least one embodiment of the inventive disclosures made herein, the latching member includes a spring-loaded pin that is slidable between a released position and a latched position.

In at least one embodiment of the inventive disclosures made herein, the latching member is biased toward the latched position.

In at least one embodiment of the inventive disclosures made herein, a window is provided, which has a perimeter at least partially by a side wall, a front wall and a top wall of the carrier body, whereby an area defined by the window extends into the side wall, the front wall and the top wall.

These and other objects of the inventive disclosures made herein will become readily apparent upon further review of the following specification and associated drawings.

### BRIEF DESCRIPTION OF THE DRAWINGS

FIGS. 1 depicts a pet carrier in accordance with an embodiment of the inventive disclosures made herein.

FIGS. 2 and 3 depict a mounting system in accordance with an embodiment of the disclosures made herein, which is in combination with the pet carrier depicted in FIG. 1.

### DETAILED DESCRIPTION OF THE DRAWINGS

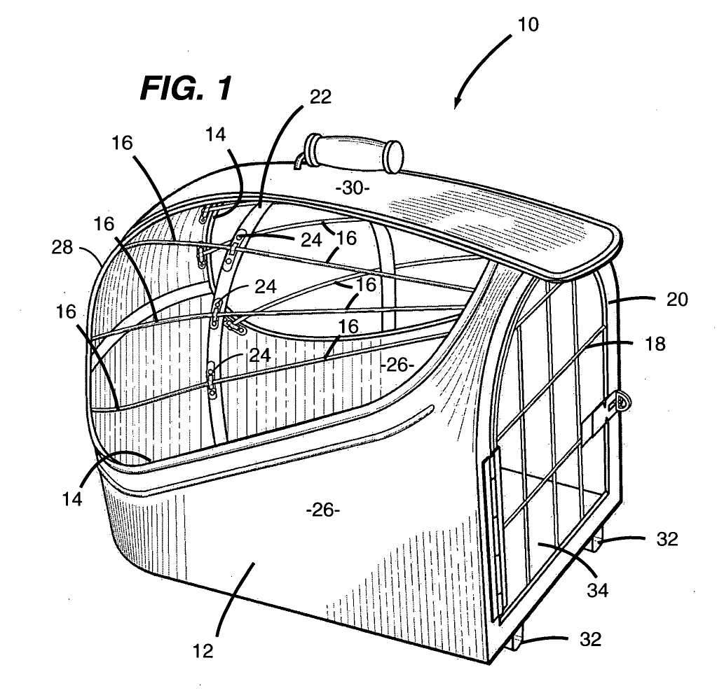

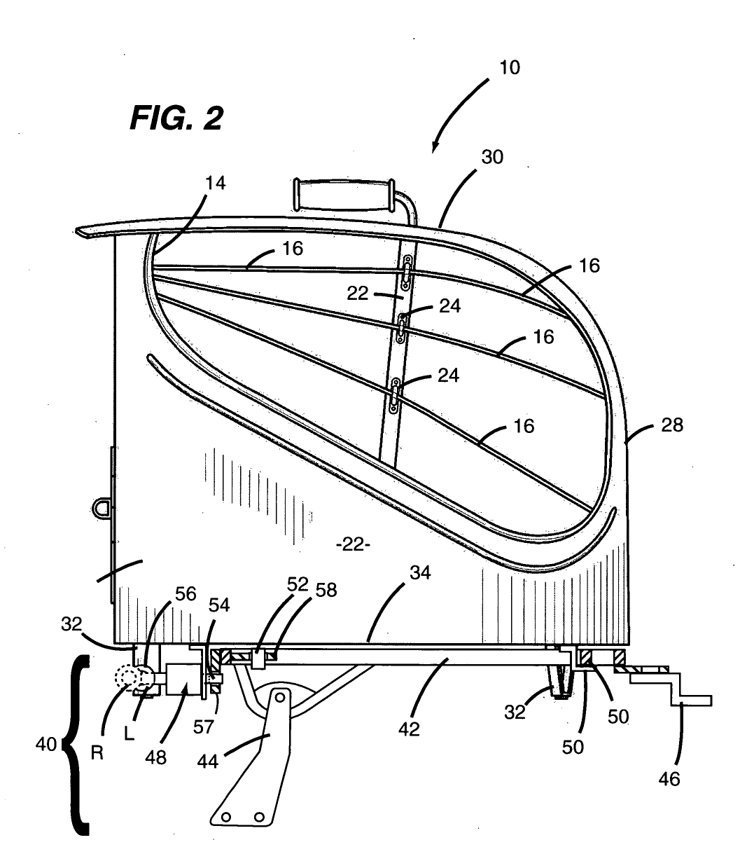

FIGS. 1 and 2 depict a pet carrier 10 in accordance with an embodiment of the inventive disclosures made herein. The pet carrier 10 includes a carrier body 12 having a plurality of windows 14 in one or more walls of the carrier body 12 and includes a plurality of containment members 16 mounted on the carrier body. A first set of the containment members 16 extend at least partially across a first one of the windows 14. A second set of the containment members 16 extend at least partially across a first one of the windows 14. An access door 18 is movably mounted (e.g., via a hinge) on carrier body 12 for enabling access to an interior space of the carrier body via an access opening 20 and confinement of a pet therein.

A plurality of support members 22 are mounted on the carrier body 12. A first one of the support members 22 extends at least partially across the first one of the windows 14. A second one of the support members 22 extends at least partially across the second one of the windows 14. At least a portion of the containment members 16 are attached to a respective one of the support members 22 (e.g., via detachable mounting brackets 24).

In one embodiment, at least a portion of one of the containment members 16 is selectively demountable from and remountable on the carrier body 12. In essence, the containment members 16 are modular such that any combination of the containment members can be removed. For example, a portion of one of the containment members 16 extending between a respective one of the support members 22 and an edge of a respective one of the windows 14 may be removed (e.g., by unscrewing associated mounting brackets). In this manner, a pet within the pet carrier 10 is able to at least partially extend its head through one of the windows 14 thereby enhancing the pet's travel experience. The pet enjoys an open-air feeling while still being constrained from escaping from the confines of the carrier body 12.

Preferably, as depicted, a perimeter of each one of the windows 14 defined at least partially by a respective side wall 26, a front wall 28 and a top wall 30 of the carrier body 12. Accordingly, each one of the windows 14 defines a window area that extends into the respective side wall 26, the front wall 28 and the top wall 30. Advantageously, such a window arrangement provides for enhanced visibility by a pet contained within the pet carrier 10.

A plurality of legs 32 are attached to a bottom wall 34 (i.e., the floor) of the carrier body 12. The legs 32 serve to elevate the carrier body from an underlying support surface (e.g., the ground), thereby providing clearance for other components positioned under the bottom wall 34 of the carrier body 12.

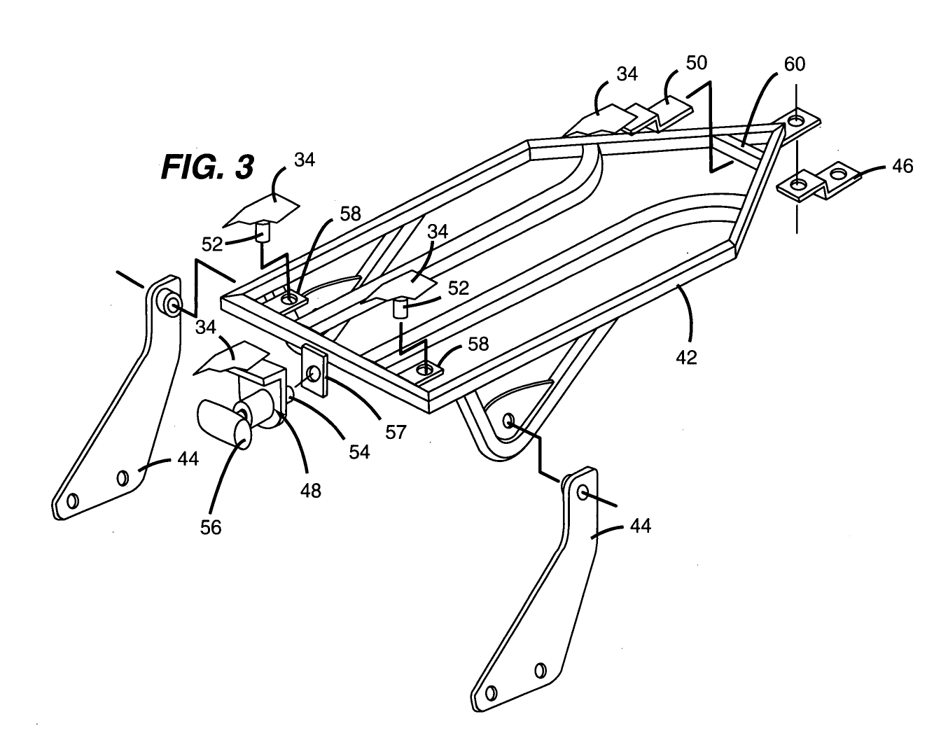

Referring now to FIGS. 2 and 3, a mounting system 40 in accordance with an embodiment of the disclosures made herein is depicted. The mounting system 40 is configured for attaching the carrier body 12 to a structural component (e.g., a chassis) of a cycle. For clarity, the legs 32 that would otherwise be in front the carrier support apparatus 40 in of FIG. 2 are omitted.

The mounting system 40 includes a mounting base 42, rear base mounting brackets 44, a forward base mounting bracket 46, a carrier latching member 48, a carrier retention bracket 50, and carrier alignment members 52. The rear base mounting brackets 44 and the forward base mounting bracket 46 are configured for being attached between the mounting base 42 and a structural component (e.g., chassis or fender) of a cycle. For example, the rear base mounting brackets 44 are attachable to backrest side plates of a cycle and the forward base mounting bracket 46 is attachable a front seat mounting pillion. The carrier latching member 48, the carrier retention bracket 50, and the carrier alignment members 52 are attached to the bottom wall 34 of the carrier body 12 and are configured for enabling carrier body 12 to be selective mounted on and demounted from the mounting base 42.

The carrier latching member 48 is attached to the bottom wall 34 of the carrier body 12 and includes a spring-loaded pin 54 that is coupled to a handle 56. The pin 54 engages a respective mating member 57 (e.g., a plate with a hole formed therethrough) of the mounting base 42. Accordingly, the carrier latching member 48 selectively limits vertical displacement at the rear of the carrier body 12 with respect to the mounting base 42 and enables the carrier body to be selectively mounted on and demounted from the mounting base 42. Furthermore, such a carrier latching member 48 advantageously enables the carrier body 12 to be mounted on and demounted from the mounting base 42 rapidly, simply and without the use of tools.

It is contemplated and disclosed herein that, in at least one embodiment of the inventive disclosures made herein, the carrier latching member 48 includes means for being locked in the latched position L. When locked, theft of the pet carrier 10 from its mounted position is deterred. Similarly, separate means for locking the carrier body 12 to the mounting base 42 may be provided for deterring theft.

To enable such selective mounting and demounting of the carrier body 12, the spring loaded pin 54 is slidable between a released position and a latched position in response to the handle 56 being moved between a corresponding released position R and latched position L. The spring loaded pin 54 is biased toward the latched position. When the carrier body is positioned on the mounting base 42, the pin 54 is engaged with the respective mating member 57 when in the latched position and is released from the mating member 57 when in the released position.

The carrier alignment members 52 each comprise a pin that is attached to and extend generally perpendicular from the bottom wall 34 of the carrier body 12. The carrier alignment members 52 engage respective mating members 58 of the mounting base 42 (e.g., plates with holes formed therethrough). The carrier alignment members 52 are engagable with and disengagable from the respective mating members 58 of the mounting base 42. Accordingly, the carrier alignment members 52 and the mating members 58 limit longitudinal and lateral displacement of the carrier body 12 with respect to the mounting base 42.

The carrier retention bracket 50 is mounted on bottom wall 34 of the carrier body 12. The carrier retention bracket 50 engages a respective mating member 60 (e.g., a cross bar) of the mounting base 42. The carrier retention bracket 50 is engagable with and disengagable from the respective mating member 60 of the mounting base 42. Accordingly, the carrier retention bracket 50 limits vertical displacement at the front of the carrier body 12 with respect to the mounting base 42 and enables the carrier body 12 to be selectively mounted on and demounted from the mounting base 42.

In one embodiment, a carrier support apparatus in accordance with the inventive disclosures made herein comprises the mounting base 42, the rear base mounting brackets 44 and the forward base mounting bracket 46. In one embodiment, a carrier retention apparatus in accordance with the inventive disclosures made herein comprises the carrier latching member 48, the carrier retention bracket 50, and the carrier alignment members 52. In one embodiment, a pet carrier system in accordance with the inventive disclosures made herein comprises a carrier body, a carrier retention apparatus and a carrier support apparatus.

It is contemplated and disclosed herein that specific placement/orientation of the carrier latching member 48, the carrier retention bracket 50, and/or the carrier alignment members 52 are limited by functionality and not a particular location. For example, the carrier latching member 48 may be located adjacent the front of the carrier body 12 and the carrier retention bracket may be located adjacent the rear of the carrier body 12 (i.e., opposite as depicted in FIGS. 2 and 3). It is also contemplated that components of the carrier retention apparatus may be attached to the mounting base 42 and mating components may be attached to the carrier body 12.

It is contemplated and disclosed herein that other types of latching arrangements that enable selective mounting and demounting of the carrier body 12 (e.g., a rotating shaft with hooks that engage mating members) may be implemented. To this end, the objective for a carrier support apparatus and carrier retention apparatus in accordance with embodiments of the inventive disclosures made herein is that the carrier body 12 is selectively mountable on and demountable from the mounting base 42 in a safe, reliable and convenient manner.

Preferably, the mounting base 42 is a universal mounting base that is compatible with a plurality of applications. For example, the mounting base 42 is preferably compatible with a plurality of different models of cycles. Depending on the specific model of cycle and/or owner preference, the pet carrier 10 will preferably be positioned either over the rear fender behind the seat or over a rear portion of the seat. To facilitate compatibility of such a universal mounting base with a plurality of applications (e.g., different models of cycles), the rear base mounting brackets 44 and/or the forward base mounting bracket 46 are application-specific mounting brackets. For example, the rear base mounting brackets 44 and/or the forward base mounting bracket 46 have a first portion (e.g., a first end) configured for being attached to the universal mounting base 42 and a second portion (e.g., a second end) configured for being attached to a structural component of a designated cycle. In this manner, a carrier support apparatus in accordance with an embodiment of the inventive disclosures made herein is configured for being attached between the universal mounting base (e.g., the mounting base 42) and a structural component of a designated cycle.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical, chemical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A pet carrier, comprising:
a carrier body having a window in at least one wall thereof; and
a plurality of containment members mounted on the carrier body and extending at least partially across the window, wherein at least one of said containment members is selectively demountable from and remountable on the carrier body.

2. The pet carrier of claim 1, further comprising:
a support member mounted on the carrier body and extending at least partially across the window, wherein at least a portion of said containment members are attached to the support member.

3. The pet carrier of claim 1, further comprising:
a carrier support apparatus attached to the carrier body, wherein the carrier support apparatus is selectively attachable to and detachable from the carrier body and is configured for being attached to a structural component of a cycle.

4. The pet carrier of claim 3 wherein the carrier support apparatus includes:
a universal mounting base configured for being selectively attachable to and detachable from the carrier body; and
an application-specific mounting bracket configured for being attached between the universal mounting base and the structural component of a designated cycle.

5. The pet carrier of claim 3 further comprising:
a latching member mounted on the carrier body and engaged with a respective mating member of the carrier support apparatus, wherein the latching member is selectively engagable with and disengagable from the respective mating member of the carrier support apparatus;
a retention bracket mounted on the carrier body and engaged with a respective mating member of the carrier support apparatus, wherein the retention member is engagable with and disengagable from the respective mating member of the carrier support apparatus; and
an alignment member mounted on the carrier body and engaged with a respective mating member of the carrier support apparatus, wherein the alignment member is engagable with and disengagable from the respective mating member of the carrier support apparatus.

6. The pet carrier of claim 5 wherein:
the latching member includes a spring-loaded pin slidable between a released position and a latched position;
the spring loaded pin is biased toward the latched position; and
the alignment member includes a pin extending generally perpendicular to a floor of the carrier body.

7. The pet carrier of claim 1 wherein a perimeter of the window is defined at least partially by a side wall, a front wall and a top wall of the carrier body, whereby an area defined by the window extends into the side wall, the front wall and the top wall.

8. The pet carrier of claim 1, further comprising:
a support member mounted at least partially across the window, wherein at least a portion of said containment members are attached to the support member;
a carrier support apparatus attached to the carrier body, wherein the carrier support apparatus is selectively attachable to and detachable from the carrier body and is configured for being attached to a structural component of a cycle;
a latching member mounted on the carrier body and engaged with a respective mating member of the carrier support apparatus, wherein the latching member is selectively engagable with and disengagable from the respective mating member of the carrier support apparatus;
a retention bracket mounted on the carrier body and engaged with a respective mating member of the carrier support apparatus, wherein the retention member is engagable with and disengagable from the respective mating member of the carrier support apparatus; and
an alignment member mounted on the carrier body and engaged with a respective mating member of the carrier support apparatus, wherein the alignment member is engagable with and disengagable from the respective mating member of the carrier support apparatus.

9. The pet carrier of claim 8 wherein the carrier support apparatus includes:
a universal mounting base configured for being selectively attachable to and detachable from the carrier body; and
an application-specific mounting bracket configured for being attached between the universal mounting base and a structural component of a designated cycle.

10. The pet carrier of claim 8 wherein a perimeter of the window is defined at least partially by a side wall, a front wall and a top wall of the carrier body, whereby an area defined by the window extends into the side wall, the front wall and the top wall.

11. A pet carrier, comprising:
a carrier body; and
a carrier support apparatus attached to the carrier body, wherein the carrier support apparatus:
is selectively attachable to and detachable from the carrier body;
is configured for being attached to a structural component of a cycle;
includes a universal mounting base configured for being selectively attachable to and detachable from the carrier body; and
includes an application-specific mounting bracket configured for being attached between the universal mounting base and a structural component of a designated cycle.

12. The pet carrier of claim 11, further comprising:
a latching member mounted on the carrier body and engaged with a respective mating member of the carrier support apparatus, wherein the latching member is selectively engagable with and disengagable from the respective mating member of the carrier support apparatus;
a retention bracket mounted on the carrier body and engaged with a respective mating member of the carrier support apparatus, wherein the retention member is engagable with and disengagable from the respective mating member of the carrier support apparatus; and
an alignment member mounted on the carrier body and engaged with a respective mating member of the carrier support apparatus, wherein the alignment member is engagable with and disengagable from the respective mating member of the carrier support apparatus.

13. The pet carrier of claim 11, further comprising:
a plurality of containment members mounted on the carrier body and extending at least partially across a window in a wall of the carrier body, wherein at least a one of said containment members is selectively demountable from and remountable on the carrier body.

14. The pet carrier of claim 13 wherein a perimeter of the window is defined at least partially by a side wall, a front wall and a top wall of the carrier body, whereby an area defined by the window extends into the side wall, the front wall and the top wall.

15. The pet carrier of claim 13, further comprising:
a support member mounted on the carrier body and extending at least partially across the window, wherein at least a portion of said containment members are attached to the support member.

16. A pet carrier system, comprising:
a carrier body assembly including a carrier body and a support member, wherein the carrier body has a window in a wall thereof and a support member mounted thereon extending at least partially across the window;
containment members selectively mountable on and demountable from the carrier body for extending at least partially across the window, wherein said containment members are attachable to the support member; and
a carrier support apparatus selectively attachable to and detachable from the carrier body and configured for being attached to a structural component of a cycle.

17. The pet carrier of claim 16 wherein the carrier support apparatus includes:
a universal mounting base configured for being selectively attachable to and detachable from the carrier body; and
an application-specific mounting bracket configured for being attached between the universal mounting base and a structural component of a designated cycle.

18. The pet carrier of claim 16 wherein the carrier body further comprises:
a latching member mounted on the carrier body, wherein the latching member is selectively engagable with and disengagable from the respective mating member of the carrier support apparatus;
a retention bracket mounted on the carrier body, wherein the retention member is engagable with and disengagable from the respective mating member of the carrier support apparatus; and
an alignment member mounted on the carrier body, wherein the alignment member is engagable with and disengagable from the respective mating member of the carrier support apparatus.

19. The pet carrier of claim 18 wherein the carrier support apparatus includes:
a universal mounting base configured for being selectively attachable to and detachable from the carrier body; and
an application-specific mounting bracket configured for being attached between the universal mounting base and a structural component of a designated cycle.

20. The pet carrier of claim 18 wherein a perimeter of the window is defined at least partially by a side wall, a front wall and a top wall of the carrier body, whereby an area defined by the window extends into the side wall, the front wall and the top wall.
